(19) United States
(12) Patent Application Publication
(10) Pub. No.: US 2018/0213150 A1
(43) Pub. Date: Jul. 26, 2018

(54) ADAPTIVE BUFFERING RATE TECHNOLOGY FOR ZERO SHUTTER LAG (ZSL) CAMERA-INCLUSIVE DEVICES

(71) Applicant: QUALCOMM Incorporated, San Diego, CA (US)

(72) Inventors: Gaurav Gagrani, Kota (IN); Ajay Kumar Dhiman, Muzaffarnagar (IN); Atishay Tibrewal, Gorakhpur (IN); Ajay Kumar, Muzaffarnagar (IN)

(21) Appl. No.: 15/414,030

(22) Filed: Jan. 24, 2017

(51) Int. Cl. H04N 5/232; H04N 5/907

(52) U.S. Cl. CPC H04N 5/23232; H04N 5/23293; H04N 5/907; H04N 5/23245

(57) ABSTRACT

An example device includes camera hardware, processing circuitry, and a memory device implementing a buffer. The processing circuitry is configured to store a first subset of frames received by the camera hardware to a buffer, according to a first buffering rate, to determine scene-change information associated with at least one of the received frames, and to determine a second buffering rate, based on the determined scene-change information. The processing circuitry is further configured to store a second subset of the received frames to the buffer according to the second buffering rate, the second plurality of received frames including different pictures from the pictures of the first plurality of received frames.

### TECHNICAL FIELD

This disclosure generally relates to image buffering, and more particularly, to buffering rate adaptations that can be implemented by devices that incorporate digital camera technologies and implement zero shutter lag (ZSL) technology.

### BACKGROUND

Digital camera technology has largely replaced film-based camera technology in recent years, and has become a virtually ubiquitous choice for the larger user base of photography equipment. Digital camera technology differs from film-based camera technology in that the image pickup components of digital cameras are electronic-based, instead of chemical-based in the case of film-based camera technology. Digital cameras (or “digicams”) are devices that encode digital images and videos in a storable format. Digital cameras capture and encode both digital still images and digital videos, the latter of which comprises so called “moving picture” data. With increasing device integration, digital camera technology is now commonly integrated into multi-use computing devices, such as smartphones, tablet computers, etc.

Whether implemented as a standalone digital camera, such as a digital single-lens reflex (DSLR) camera, or in the context of a more integrated device, digital camera technology has evolved to incorporate “zero shutter lag” (ZSL) capabilities. ZSL technology enables the digital camera to more accurately respond to a user command, by more accurately capturing a scene that the user attempted to photograph. ZSL technology is generally designed to compensate for lag time that may occur from an output time of a scene being via a display of the digital camera, until the digital camera finishes encoding and storing a picture in response to a “capture” command received from the user. The lag time may occur due to one or more factors, such as human reaction time, resource limitations of the digital camera, and various others.

A ZSL-enabled digital camera continually stores one or more of the most recently received frames to a snapshot buffer of a memory device, and matches the receipt time of a capture command to one of the stored images. In turn, upon processing a capture command received from a user, the digital camera selects one of the buffered snapshots, and further processes the selected snapshot for storing and presentation as a digital photograph. In this way, ZSL-enabled digital cameras enable a more accurate photo capture in response to a user input to record a digital photograph. To compensate for commonly-exhibited lag times, many ZSL-enabled digicams continually buffer image data captured over the last ninety-nine milliseconds (99 ms). To support video frame rates provided by modern digital cameras, the buffering of image data for the last 99 ms typically causes the digital camera to maintain two to three (2-3) frames in the snapshot buffer at any given time.

### SUMMARY

This disclosure is generally directed to enhancements that enable ZSL-equipped digital cameras to adaptively change the buffering rate at which received frames are stored to a snapshot buffer. In particular examples, the techniques of this disclosure enable image signal processing hardware of a digital camera to dynamically adjust the ZSL buffering rate, based on characteristics of images of a target scene.

In one example, this disclosure is directed to a mobile computing device having digital camera capabilities. The mobile computing device includes camera hardware configured to receive a plurality of frames, processing circuitry coupled to the camera hardware, and a memory device coupled to the processing circuitry. The memory device implements a buffer. The processing circuitry is configured to store a first subset of the plurality of received frames to a buffer, according to a first buffering rate, to determine scene-change information associated with at least one received frame of the plurality of received frames, to determine a second buffering rate based on the determined scene-change information, and to store a second subset of the plurality of received frames to the buffer according to the second buffering rate, the second subset of the plurality of received frames comprising different pictures from pictures of the first subset of the plurality of received frames.

In another example, this disclosure is directed to a method of image processing. The method includes capturing, by camera hardware of a mobile computing device, a plurality of frames, storing, by processing circuitry coupled to the camera hardware, a first subset of the plurality of received frames to a buffer, according to a first buffering rate, determining, by the processing circuitry, scene-change information associated with at least one received frame of the plurality of received frames, determining, by the processing circuitry, a second buffering rate based on the determined scene-change information; and storing, by the processing circuitry, a second subset of the plurality of received frames to the buffer according to the second buffering rate, the second subset of the plurality of received frames comprising different pictures from pictures of the first subset of the plurality of received frames. The buffer is implemented in a memory device.

In another example, this disclosure is directed to an apparatus for image processing. The apparatus includes means for capturing a plurality of frames, means for buffering a first subset of the plurality of received frames according to a first buffering rate, means for determining scene-change information associated with at least one received frame of the plurality of received frames, means for determining, based on the determined scene-change information, a second buffering rate, and means for buffering a second subset of the plurality of received frames according to the second buffering rate, the second subset of the plurality of received frames comprising different pictures from pictures of the first subset of the plurality of received frames.

In another example, this disclosure is directed to a non-transitory computer-readable storage medium encoded with instructions. When executed, the instructions cause one or more processors of an image-processing device to receive a plurality of frames, to buffer a first subset of the plurality of received frames according to a first buffering rate, to determine scene-change information associated with at least one received frame of the plurality of received frames, to determine, based on the determined scene-change information, a second buffering rate, and to buffer a second subset of the plurality of received frames according to the second buffering rate, the second subset of the plurality of received frames comprising different pictures from pictures of the first subset of the plurality of received frames.

The details of one or more examples of the techniques are set forth in the accompanying drawings and the description below. Other features, objects, and advantages of the techniques will be apparent from the description, drawings, and from the claims.

### BRIEF DESCRIPTION OF THE DRAWINGS

FIG. 1 is a block diagram illustrating aspects of a computing device that includes digital camera circuitry configured to perform various techniques of this disclosure.

FIG. 2 is a block diagram illustrating example implementations of various digital camera components of the computing device of FIG. 1 in more detail.

FIGS. 3A and 3B are conceptual diagrams illustrating frame sequences that an image signal processing (ISP) engine configured according to aspects of this disclosure may buffer at different adaptive buffering rates.

FIG. 4 is a data flow diagram (DFD) illustrating an example of interactive operation of various hardware components configured to perform various aspects of the techniques described in this disclosure.

FIG. 5 is a flowchart illustrating an example process by which the mobile computing device of FIG. 1 may implement the adaptive buffering rate technologies of this disclosure to mitigate resource consumption while supporting the enhanced user experience provided by ZSL.

### DETAILED DESCRIPTION

This disclosure is generally directed to enhancements that enable ZSL-equipped digital cameras to adaptively change the buffering rate at which received frames are stored to a snapshot buffer. A digital camera may implement ZSL-based buffering based on a user activation of certain functionalities. For example, if a digital camera is incorporated into a smartphone device, the digital camera's logic circuitry may activate image buffering upon detecting that a user has activated a camera application, or “app,” on the smartphone. So long as the camera app is running, the digital camera may continually buffer the most recent two to three received frames in a snapshot buffer. For ease of discussion, this disclosure uses an example of a three-snapshot buffering scheme, in accordance with a thirty frames per second (30 fps) frame rate with respect to video capture.

The continual buffering of the last three images may cause significant resource consumption by the digital camera. As one example, the digital camera may expend significant power to continually store the three most recently received frames to the snapshot buffer. With the ever-increasing resolution of digital photos, each buffered image also requires greater buffer space and causes increased power consumption. Digital camera technology may also evolve to support greater frame rates. At a greater frame rate, in order to support 99 ms worth of image buffering, the digital camera may need to maintain greater than three images in the snapshot buffer at a given time. Additionally, to support the same lag time compensation at a greater frame rate, the digital camera may need to update the snapshot buffer at a faster pace. Factors such as those discussed above may result in greater power consumption, as well as greater consumption of memory resources and more frequent erase-and-write activity of the snapshot buffer.

As such, ZSL-enabled digital camera technology expends battery resources and wears down flash memory at a significant rate. Moreover, in many cases, a ZSL-enabled digital camera may continually buffer identical or substantially similar images. For instance, if a user is attempting focus on a stationary or relatively stationary scene, the digital camera may continually buffer images of the same stationary scene for the entire time that the user is contemplating capturing a photo. The techniques of this disclosure are generally directed to adaptively slowing the buffering rate based on a level of stasis, which is an extent to which the received frames are directed to a stationary scene. Said another way, digital cameras configured according to aspects of this disclosure may “skip” the buffering of some frames, while maintaining ZSL support. The degree of the buffering rate reduction implemented by a digital camera configured according to this disclosure may also be expressed as a “skip rate” throughout this disclosure.

The techniques described herein may provide one or more potential advantages over existing ZSL technology. As one example, a digital camera or digital camera-inclusive device configured to implement the adaptive buffering techniques of this disclosure may conserve battery resources. More specifically, the adaptive buffering aspects of this disclosure enable a ZSL-enabled digital camera to reduce the frequency at which images are stored to the snapshot buffer, thereby reducing the power consumption caused by image buffering performed to support ZSL. Additionally, a ZSL-enabled digital camera may implement the adaptive buffering techniques of this disclosure to improve the efficiency of memory resource consumption. For instance, by reducing the buffering imposition on random access memory (RAM) resources, the digital camera may enable other components (e.g., of a smartphone that includes the digital camera) to more easily access the memory resources that a reduced buffering rate access less frequently. Moreover, a digital camera may prolong the life of cells of the random access memory, by eliminating some potentially unnecessary erase-and-write operations. The adaptive buffering technology of this disclosure can be implemented at various levels of granularity, thereby enabling a digital camera to use different magnitudes of reduction (e.g., implement different skip rates) based on different degrees of stasis of a scene being photographed.

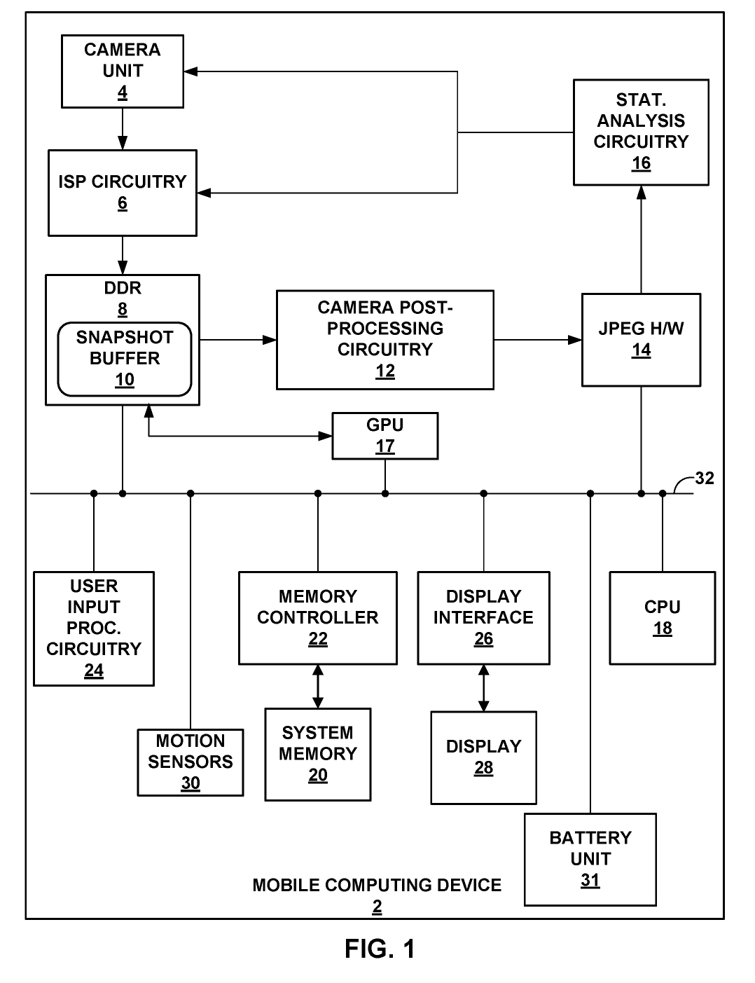

FIG. 1 is a block diagram illustrating aspects of a computing device that includes digital camera circuitry configured to perform various techniques of this disclosure. In the example of FIG. 1, the computing device is labeled as mobile computing device 2. Mobile computing device 2 may include, be, or be part of various types of computing devices, such as a laptop computer, a wireless communication device or handset (such as, e.g., a mobile telephone, a cellular telephone, a so-called “smart phone” or “smartphone,” a satellite telephone, and/or a mobile telephone handset), a handheld device (such as a portable video game device or a personal digital assistant (PDA)), a tablet computer, a personal music player, a standalone digital camera (“digital camera”), a portable video player, a portable display device, or any other type of mobile device that includes camera-related circuitry to capture photos or other types of image data. While described with respect to mobile computing device 2, the techniques may be implemented by any type of device, whether considered mobile or not, such as by a desktop computer, a workstation, a set-top box, a television, or a webcam-inclusive monitor, to provide a few examples.

As illustrated in the example of FIG. 1, mobile computing device 2 includes a camera unit 4, image signal processing (ISP) circuitry 6, and double data rate (DDR) synchronous dynamic random-access memory 8 (shortened to “DDR 8”). In the example of FIG. 1, DDR 8 implements a snapshot buffer 10. Mobile computing device 2 further includes camera post-processing circuitry 12, JPEG hardware 14, and statistical analysis circuitry 16. Mobile computing device 2 also includes a graphical processing unit (GPU) 17, a central processing unit (CPU) 18, system memory 20, and a memory controller 22 that provides access to system memory 20. Mobile computing device 2 also includes user input processing circuitry 24, a display interface 26 that outputs signals that cause graphical data to be visually output via display 28, and one or more motion sensors 30.

Although the various circuitry components are illustrated as separate, distinct circuitry components in FIG. 1, in some examples, two or more of the illustrated components may be combined to form a system on a chip (SoC). As an example, two or more of ISP circuitry 6, camera post-processing circuitry 12, statistical analysis circuitry 16, and display interface 26 may be formed on a common chip. In other examples, two or more of ISP circuitry 6, camera post-processing circuitry 12, statistical analysis circuitry 16, and display interface 26 may be formed on separate chips.

The various components illustrated in FIG. 1 may be formed in one or more microprocessors, application specific integrated circuits (ASICs), field programmable gate arrays (FPGAs), digital signal processors (DSPs), processing circuitry (including fixed function circuitry and/or programmable processing circuitry), or other equivalent integrated or discrete logic circuitry. Examples of system memory 20 include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media. As described above, DDR 8 may include, be, or be part of double data rate synchronous dynamic RAM, which is a form of integrated circuits used to implement memory. DDR 8 may include any commercially-available class of DDR RAM integrated circuitry, including DDR4 SDRAM, or any of its slower-speed predecessors, namely, DDR3, DDR2, or DDR1 SDRAM integrated circuitry. As such, DDR 8 may include, be, or be part of one or more memory devices that conform to DDR SDRAM technology of any generation.

As illustrated in FIG. 1, mobile computing device 2 also includes a battery unit 31. Although battery unit 31 is shown as a single unit in FIG. 1 for ease of illustration, it will be appreciated that battery unit 31 may represent one or more batteries and/or battery backup power supplies that may deliver electrical power to mobile computing device 2 and its various components. Battery unit 31 may represent power supplies that implement one or more of lithium-polymer technology, lithium ion technology, and various other technologies. Moreover, in some cases, battery unit 31 may encompass power supplies that are external to mobile device 2, such as a portable power bank that can interface with mobile computing device 2 via a multi-use port, such as a USB-C® or micro-USB® port.

Various circuitry components of mobile computing device 2 illustrated in FIG. 1 communicate with each other over bus 32. Bus 32 may include, be, or be part of any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It will be appreciated that the specific configuration of buses and communication interfaces between the different circuitry components shown in FIG. 1 is merely exemplary, and other configurations of computing devices and/or other image processing systems with the same or different components may be used to implement the techniques of this disclosure. Moreover, battery unit 31 is illustrated as being connected to bus 32 as an example, and in various examples, battery unit 31 may be connected to a power delivery system instead of being connected to bus 32.

Camera unit 4 of mobile computing device 2 may include various image capture hardware, other hardware that assists in image capture, circuitry configured to drive the camera sensor hardware, and processing circuitry for processing image data. As examples of image-capturing hardware, camera unit 4 may include one or more lenses and one or more sensors. For instance, the sensors may include photodetector hardware, one or more amplifiers, one or more transistors, processing hardware, and complementary metal-oxide-semiconductor (CMOS) sensor hardware. Aspects of camera unit 4 may incorporate photosensor elements having photoconductivity (e.g., the elements that capture light particles in the viewing spectrum or outside the viewing spectrum), and elements that can conduct electricity based on intensity of the light energy (e.g., infrared or visible light) striking their respective surfaces. Various elements of camera unit 4 may be formed with germanium, gallium, selenium, silicon with dopants, or certain metal oxides and sulfides, as a few non-limiting examples.

In many use case scenarios, camera unit 4 may include two or more sets of lens-sensor hardware that can, but do not necessarily, operate exclusively of each other. For instance, in some cases where mobile computing device 2 is a smartphone, camera unit 4 may include a front-facing camera and a rear-facing camera. As examples of capture-assisting hardware, camera unit 4 may incorporate one or more light-emitting devices, such as a flash unit that includes a photoflash light-emitting diode (LED), or illumination-providing components of display 28 that double as a flash unit with respect to a front-facing camera of camera unit 4.

As described above, camera unit 4 includes processing circuitry configured to perform some amount of image processing on received image data. For instance, the processing circuitry of camera unit 4 may include image generation circuitry, which generates raw image data based on data received by the sensor hardware and optionally enhanced by other components, such as flash unit(s) of camera unit 4. Upon generating the raw data for a received image, camera unit 4 may provide the raw image to image signal processing (ISP) circuitry 6. An image that is output by camera unit 4 is referred to herein as a “raw image” even though it will be understood that camera unit 4 and its components may implement some level of image processing during image generation or at another stage before outputting the image to ISP circuitry 6.

ISP circuitry 6 represents hardware configured to refine raw image data received from camera unit 4. ISP circuitry 6 may include, be, or be part of one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry. In some examples, portions of ISP circuitry 6 may be referred to as a “video front end” or “VFE” engine.

ISP circuitry 6 may refine or “touch up” a raw image received from camera unit 4, and may also extract descriptive information or “metadata” with respect to the image. To refine an image received from camera unit 4, ISP circuitry 6 may apply one or more filters to sharpen the image, such as automatic varifocal filtering (AVF), pixelwise dark channel prior (PDCP) filters, and other filters. ISP circuitry 6 may also implement noise reduction or noise removal, de-mosaicing, black level correction, pixel correction (e.g., to identify faulty pixels and then predict the faulty pixels from neighboring pixels), and/or color conversion (e.g., to downscale or downsample an image from a higher resolution to a lower resolution). Generally, ISP circuitry 6 may apply de-mosaicing to update the color and brightness of image pixels.

Additionally, ISP circuitry 6 may store one or more of these touched-up images to DDR 8. For instance, ISP circuitry 6 may support zero shutter lag (ZSL) technology, by continually storing the touched-up images to DDR 8, or more specifically, to snapshot buffer 10 that is implemented in DDR 8. For instance, ISP circuitry 6 may continually store the most-recently refined image to snapshot buffer 10, and optionally, may store one or more refined images that immediately precede the most-recently stored image in chronological order of capture by camera unit 4.

For instance, ISP circuitry 6 may support ZSL technology by implementing an erase-and-write scheme by which ISP circuitry 6 maintains a set of images reflecting image capture performed by camera unit 4 over the last ninety-nine milliseconds (99 ms). In accordance with an implementation in which camera unit 4 implements a thirty frames per second (30 fps) frame rate, ISP circuitry 6 may maintain the three most recently processed images in snapshot buffer 10. By maintaining the three most recently processed images in snapshot buffer 10 in a 30 fps frame rate implementation, ISP circuitry 6 supports ZSL by enabling other components of mobile computing device 2 to respond to a “capture” command by selecting an image that accurately represents a scene that a user attempted to photograph.

For instance, user input processing circuitry 24 may process a user input that reflects a capture command. In examples where mobile computing device 2 is a smartphone and display 28 is an input/output capable device, such as a touchscreen, user input processing circuitry 24 may receive data over bus 32 that indicates receipt of a “click” on a capture button displayed via display 28. In other examples, whether mobile computing device 2 represents a smartphone, standalone digital camera, or other device, user input processing circuitry 24 may detect the capture command based on an actuation of a physical button. Upon detecting a capture command, and optionally, discerning a timestamp associated with the receipt of the command, user input processing circuitry 24 may cause CPU 18 to retrieve one of the three currently-stored images from snapshot buffer 10 for further processing and storage as a user-identified photograph.

As described above, in a 30 fps frame rate implementation, snapshot buffer 10 may, at any given time, include three processed images. Again, ISP circuitry 6 may store different numbers of frames in snapshot buffer 10 to support different frame rates, but the 30 fps frame rate example is used throughout this disclosure purely for illustrative purposes. In examples where camera unit 4 supports image resolutions that in the order of tens of megapixels, ISP circuitry 6 may implement not only frequent, but relatively data-rich erase-and-write operations in snapshot buffer 10 to support ZSL. For instance, many cameras that are available commercially support image resolutions as high as twenty-one megapixels (21 MP). Several portions of this disclosure use examples and experimental results in which camera unit 4 supports image resolutions in the range of thirteen megapixels to sixteen megapixels (13 MP-16 MP), which may represent a relatively low or even minimal resolution provided by camera technology that is commercially available at the time of this disclosure.

To support ZSL in a 30 fps frame rate, 13 MP-16 MP image resolution implementation, ISP circuitry 6 may expend significant resources of mobile computing device 2, such as power available from battery unit 31, and read-write access to DDR 8. Additionally, ISP circuitry 6 may cause significant wear of the flash memory cells of DDR 8 by frequently erasing and writing 13 MP-16 MP image data at a 30 fps frame rate. The resource consumption and memory wear caused by ZSL support may even become wasteful or excessive in some cases, such as if a user of mobile computing device 2 unintentionally leaves a camera application (or “app”) activated after finishing capturing all desired still photographs or videos.

As discussed above, CPU 18 may select a picture from snapshot buffer 10 in response to processing a capture command relayed by user input processing circuitry 24. For instance, CPU 18 may select, from snapshot buffer 10, a picture for further processing and storage as a user-captured photograph. Based on CPU 18 selecting a particular picture from snapshot buffer 10, camera post processing (CPP) circuitry 12 may access the selected picture, for further processing. CPP circuitry 12 may further refine the selected image, in addition to the initial touch-ups applied by ISP circuitry 6. In contrast to ISP circuitry 6, which represents “front end” processing circuitry with respect to image processing performed at mobile computing device 2, CPP circuitry 12 represents “back end” processing circuitry. That is, while ISP circuitry 6 applies image processing (e.g., filters) on all images received using the hardware of camera unit 4. In contrast, CPP circuitry 12 processes only those images that CPU 18 has already selected from snapshot buffer 10 for processing and storage as a user-captured photograph.

Again, in response to a picture selection performed by CPU 18, CPP circuitry 12 may extract the selected picture from snapshot buffer 10. In turn, CPP circuitry 12 may further condition the picture for use as a captured photograph. For instance, CPP circuitry 12 may apply noise reduction and sharpening to the to the extracted picture. Moreover, CPP circuitry 12 may apply additional filtering to the extracted picture, to further refine the picture beyond the front-end filtering applied by ISP circuitry 6. As such, CPP circuitry 12 may apply a different set of filters from a set of filters applied by ISP circuitry 6. As examples, CPP circuitry 12 may apply sharpness filters, such as one or more of an adaptive spatial filtering (ASF), wavelet noise reduction, and temporal noise reduction. CPP circuitry 12 may be configured with rotation capabilities and thus, CPP circuitry 12 may also compute inverse transformations for individual pixels of the extracted picture.

The various filtering technologies that CPP circuitry 12 is configured to apply may represent relatively resource-heavy or resource-intensive filtering techniques in comparison to the front-end filtering techniques applied by ISP circuitry 6. For this reason, CPP circuitry 12 implements the above discussed filters as part of back-end filtering. More specifically, by reserving the resource-intensive filter sets for back-end implementation, CPP circuitry 12 may limit the resource-intensive (e.g., processor-intensive) filtering techniques to be applied only to select pictures that have been identified for further refining and storage. In this way, CPP circuitry 12 may reduce the burden on one or more of GPU 17, CPU 18, DDR 8, and other hardware of mobile computing device 2 by reserving certain filtering techniques for back-end implementation only with respect to select pictures.

CPP circuitry 12 may provide the processed picture to JPEG hardware 14 for further refinement and processing. In turn, JPEG hardware 14 may provide the processed picture to statistical analysis circuitry 16. Statistical analysis circuitry 16 may include, be, or be part of one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry. Statistical analysis circuitry 16 may be configured to extract and/or analyze descriptive information, or so-called “metadata” with respect to the picture received from JPEG hardware 14. For instance, statistical analysis circuitry 16 may extract statistical data, also referred to as statistics or “stats” from the picture.

According to various aspects of this disclosure, statistical analysis circuitry 16 may be configured to extrapolate and/or analyze picture statistics that are indicative of scene change information. As some non-limiting examples, statistical analysis circuitry 16 may extrapolate metadata indicating color transitions, motion blur, changes in white balance, sharpness changes (sharpening or dulling) and other picture characteristics. Statistical analysis circuitry 16 may also analyze metadata that is based on red-green-blue (RBG) color filtering gains, in accordance with a Bayer filter. For instance, with respect to Bayer filtering, statistical analysis circuitry 16 may determine RGB filtering gains to determine metadata indicating color transitions as caused by varying light energies. Statistical analysis circuitry 16 may analyze the metadata to determine a degree of scene change, such as to determine how “dynamic” or “fluid” the currently-photographed target is.

If statistical analysis circuitry 16 determines that the analyzed picture exhibits no (e.g., zero) scene change, then statistical analysis circuitry 16 may determine that the picture is directed to a stationary target scene. If statistical analysis circuitry 16 determines that the picture exhibits some amount of scene change-indicating information, but that the amount is below a predetermined threshold, then statistical analysis circuitry 16 may determine that the picture is directed to a relatively stationary target scene. If statistical analysis circuitry 16 determines that the picture exhibits an amount of scene change-indicating characteristics that exceed the threshold, then statistical analysis circuitry 16 may determine that the picture is directed to a dynamic target scene.

While a single-threshold determination between “relatively stationary” and “dynamic” is described above as an example, it will be appreciated that statistical analysis circuitry 16 may implement the techniques of disclosure to determine and identify multiple grades of motion with respect to a picture. For instance, statistical analysis circuitry 16 may determine three grades of motion (beyond the zero motion scenario) in a picture, using two thresholds to separate the grades. In other implementations, statistical analysis circuitry 16 may be configured to identify a greater number of grades of motion in a picture than three grades.

In some implementations, statistical analysis circuitry 16 may determine motion exhibited by a picture at a more granular level. For instance, statistical analysis circuitry 16 may determine an exact or rounded percentage change from a reference picture. The reference picture may be an immediately preceding picture in chronological receipt order with respect to the picture that is currently under metadata analysis. According to such implementations, in instances where statistical analysis circuitry 16 determines that a picture exhibits 0% motion with respect to a reference picture, statistical analysis circuitry 16 may determine that camera unit 4 is aimed at a stationary scene. An example of a “relatively stationary scene” in granular implementations may be a picture that statistical analysis circuitry 16 determines to exhibit 2% motion (on a holistic, all-pixel basis) with respect to the selected reference picture.

According to various aspects of this disclosure, statistical analysis circuitry 16 may provide the extracted metadata, or inferences drawn from analyzing the metadata, to ISP circuitry 6. In this way, the circuitry configurations of this disclosure enable statistical analysis circuitry 16 to provide scene-change information as feedback to ISP circuitry 6. In contrast to, and as an enhancement over, existing camera technologies, this disclosure provides configurations by which statistical analysis circuitry 16 enables ISP circuitry 6 to access the scene-change information, and optionally, to use the scene-change information to implement decisions relating to continual storing of pictures to snapshot buffer 10.

In a grade-based implementation, statistical analysis circuitry 16 may communicate, to ISP circuitry 6, an indication of the particular motion grade that statistical analysis circuitry 16 determined with respect to a particular picture. In a granular implementation, statistical analysis circuitry 16 may communicate, to ISP circuitry 6, an indication of the percentage of motion that statistical analysis circuitry 16 detected for a picture in comparison to the reference picture. According to aspects of this disclosure, ISP circuitry 6 is configured to use the scene-change metric(s) received from statistical analysis circuitry 16 to adapt the buffering rate that ISP circuitry 6 implements with respect to storing pictures in snapshot buffer 10.

For instance, based on the scene-change metrics received from statistical analysis circuitry 16, ISP circuitry 6 may reduce the buffering rate for some period of time. By reducing the buffering rate for any period of time, ISP circuitry 6 may mitigate the drain on battery unit 31 that is customarily caused by buffering pictures received from camera unit 4 to snapshot buffer 10. Moreover, reducing the buffering rate for any period of time, ISP circuitry 6 may mitigate the wear on cells of DDR 8, and may allow other components of mobile computing device 2 to access DDR 8 more freely. The magnitude of reduction implemented by ISP circuitry 6 may be referred to herein as a “skip rate.” That is, ISP circuitry 6 may use the scene-change metrics supplied by statistical analysis circuitry 16 to determine a skip rate by which to reduce the buffering rate, thereby decreasing the resource-intensiveness of ZSL support.

In some examples, ISP circuitry 6 may implement fixed skip rates based on the particular scene-change metrics received from statistical analysis circuitry 16. For instance, if ISP circuitry 6 receives an indication of 0% change in a granular feedback scheme, or a “stationary scene” indication in a grade-based feedback scheme, then ISP circuitry 6 may implement the highest of the various fixed skip rates. ISP circuitry 6 may determine that a stationary scene warrants the lowest buffering rate allowed to adequately support ZSL. Based on this determination, ISP circuitry 6 may implement the highest available skip rate, which corresponds to the greatest magnitude of buffering rate reduction available to ISP circuitry 6. For instance, skip rate of two-thirds (˜66.67%) reduces a default buffering rate to one-third of its original value. In some examples of a two-thirds buffering rate, ISP circuitry 6 may buffer one out of every three touched-up pictures.

In some granular feedback schemes, ISP circuitry 6 may implement another, next-lower skip rate if statistical analysis circuitry 16 reports scene-change metrics that are greater than 0%, but within a threshold, such as 2%. Similarly, in some grade-based feedback schemes, ISP circuitry 6 may implement the next-lower skip rate if statistical analysis circuitry 16 reports the lowest scene-change grade that exceeds the “stationary” grade. As described above, the lowest scene-change grade exceeding the stationary grade is described as a “relatively stationary” grade. In the particular example described above, the relatively stationary grade in a grade-based scheme corresponds to a 0%-to-2% range in a granular scheme, with the lower bound being excluded.

The examples described above are directed to implementations in which ISP circuitry 6 may predetermine a set of fixed-value skip rates that ISP circuitry 6, and then select a predetermined fixed-value skip rate from the available set, depending on the scene-change metrics received from statistical analysis circuitry 16. In other examples of this disclosure, ISP circuitry 6 may be configured to dynamically set the skip rate, based on the scene-change metrics received from statistical analysis circuitry 16. For instance, in such implementations, ISP circuitry 6 may tune the skip rate based on the magnitude of scene-change information received from statistical analysis circuitry 16. For example, the magnitude of the skip rate may be directly proportional to the magnitude of the scene-change information.

In this way, ISP circuitry 6 and statistical analysis circuitry 16 are configured, according to aspects of this disclosure, to reduce the power-drain burden on battery unit 31, to reduce wear on DDR 8, and enable more efficient use of DDR 8, while continuing to maintain ZSL support. Moreover, the circuitry configurations of this disclosure leverage hardware infrastructure that is already commercially available with respect to mobile computing devices, such as tablet computers, smartphones, and standalone digital cameras. The buffering rate reduction technology of this disclosure also enables statistical analysis circuitry 16 and ISP circuitry 6 to improve the overall performance of mobile computing device 2. For instance, by reducing the buffering-related accesses to DDR 8, statistical analysis circuitry 16 and ISP circuitry 6 facilitate GPU 17 pushing greater amounts of data, with lower wait times, to DDR 8. Statistical analysis circuitry 16 and ISP circuitry 6 may facilitate access to DDR 8 by other client components of mobile computing device 2, as well. In this manner, statistical analysis circuitry 16 and ISP circuitry 6 are configured, according to various aspects of this disclosure, to support the user experience provided by ZSL, while improving performance of mobile computing device 2 and potentially prolonging the life of certain components, such as DDR 8.

In various use cases, camera unit 4 need not necessarily be part of mobile computing device 2, and may be external to mobile computing device 2. In such examples, camera unit 4 may be communicatively coupled to ISP circuitry 6, by wired or wireless means. For ease of discussion and illustration, examples of this disclosure are described with respect to camera unit 4 being part of mobile computing device 2 (e.g., such as in examples where mobile computing device 2 is a smartphone, tablet computer, handset, mobile communication handset, standalone digital camera, or the like).

CPU 18 may include, be, or be part of a general-purpose or a special-purpose processor that controls operation of various components of mobile computing device 2. A user may provide input via user to mobile computing device 2 to cause CPU 18 to execute one or more software applications. Software applications executing within the execution environment provided by CPU 18 may include, for example, an operating system, a camera application, a camcorder application, a word processor application, an email application, a spread sheet application, a media player application, a video game application, a graphical user interface application, or any another program. The user may provide input to mobile computing device 2 via one or more input devices such as a keyboard, a mouse, a microphone, a touch pad, a touch-sensitive screen, physical input buttons, virtual input button buttons output via a touch-sensitive or stylus-activated display, or another input device that is coupled to mobile computing device 2 via user input processing circuitry 24.

As one example, user input may cause CPU 18 to execute a camera/camcorder application to capture a still photograph or video file, by leveraging one or more of camera unit 4, ISP circuitry 6, CPP circuitry 12, JPEG hardware 14, or statistical analysis circuitry 16. An active camera application may present real-time image content via display 28 for the user to view prior to taking a digital photograph. In some examples, the real-time image content displayed on display 28 may be the content received via camera unit 4 and processed by ISP circuitry 6. The code for the camera application used to capture the image may be stored on system memory 20. CPU 18 may retrieve and execute object code corresponding to the camera application's code stored to system memory 20. Alternatively, CPU 18 may retrieve source code from system memory 20, and may compile the source code to obtain the object code corresponding to the camera application. In turn, CPU 18 may execute the object code to present visual (and potentially, audiovisual) data for the camera application via display 28 and optionally, one or more speakers (not shown).

Upon determining that the currently-displayed real-time image content, the user may interact, such as by actuating a graphical button output via display 28 to capture the image content as a digital photograph. In response, CPP circuitry 12 may extract a picture from snapshot buffer 10, process the picture, and forward the processed picture to JPEG hardware 14. Memory controller 22 facilitates the transfer of data going into and out of system memory 20. For example, memory controller 22 may receive memory read and write commands, and service such commands with respect to system memory 20 in order to provide memory services for the components in mobile computing device 2. Memory controller 22 is communicatively coupled to system memory 20. Although memory controller 22 is illustrated in the example mobile computing device 2 of FIG. 1 as being a unit that is separate and distinct from both CPU 18 and system memory 20, in other examples, some or all of the functionality of memory controller 22 may be implemented on one or both of CPU 18 or system memory 20.

System memory 20 may store program modules and/or instructions and/or data that are accessible by camera processor 14, CPU 16, and GPU 18. For example, system memory 20 may store user applications, resulting images from camera processor 14, intermediate data, and the like. System memory 20 may additionally store information for use by and/or generated by other components of mobile computing device 2. For example, system memory 20 may act as a device memory for GPU 17 and/or CPU 18. System memory 20 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 20 may include instructions that cause one or more of camera unit 4, ISP circuitry 6, GPU 17, CPP circuitry 12, JPEG hardware 14, statistical analysis circuitry 16, user input processing circuitry 24, display interface 26, or motion sensors 30 to perform the functions ascribed to these components in this disclosure. Accordingly, system memory 20 may represent a computer-readable storage medium having instructions stored thereon that, when executed, cause one or more processors (e.g., GPU 17, CPU 18, user input processing circuitry 24, or display interface 26) to perform various aspects of the techniques described in this disclosure.

In some examples, system memory 20 may represent a non-transitory computer-readable storage medium. The term “non-transitory” indicates that the storage medium is not embodied in a carrier wave or a propagated signal. However, the term “non-transitory” should not be interpreted to mean that system memory 20 is non-movable or that its contents are static. As one example, system memory 20 may be removed from device 2, and moved to another device. As another example, memory, substantially similar to system memory 20, may be inserted into device 2. In certain examples, a non-transitory storage medium may store data that can, over time, change (e.g., in RAM).

GPU 17, CPU 18, and user input processing circuitry 24, may store image data, and the like in respective buffers that are allocated within system memory 20 (in addition to DDR 8). Display interface 26 may retrieve the data from system memory 20 and configure display 28 to display the image represented by the rendered image data. In some examples, display interface 26 may include a digital-to-analog converter (DAC) that is configured to convert the digital values retrieved from system memory 20 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 28 may be integrated within mobile computing device 2. For instance, display 28 may be a screen of a mobile telephone handset, a tablet computer, or a standalone digital camera. Alternatively, display 28 may be a standalone device coupled to mobile computing device 2 via a wired or wireless communications link. For instance, display 28 may be a computer monitor or flat panel display connected to mobile computing device 2 via a cable or wireless link.

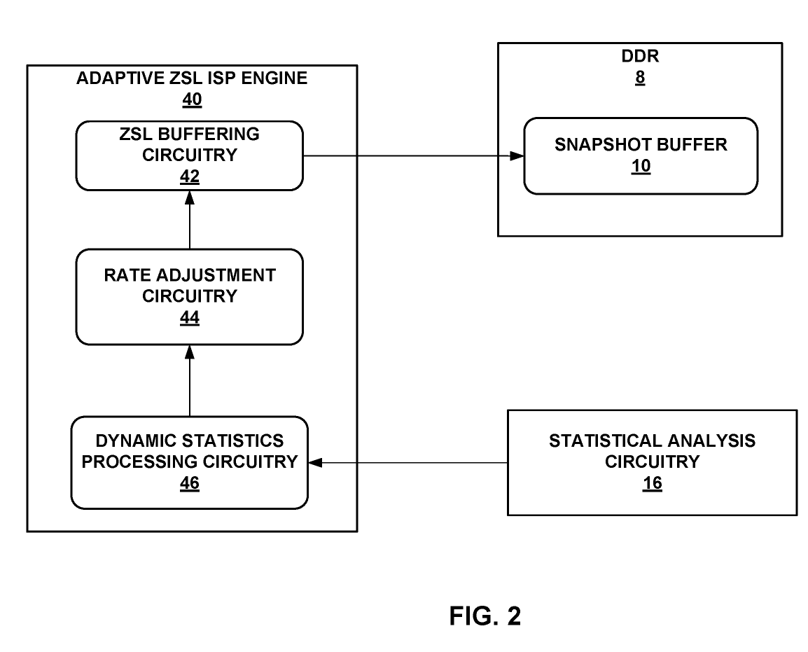

FIG. 2 is a block diagram illustrating example implementations of components of mobile computing device 2 of FIG. 1 in greater detail. Adaptive ZSL ISP engine 40 illustrated in FIG. 2 is one example implementation of ISP circuitry 6, or a subset of ISP circuitry 6, or a superset of ISP circuitry 6. Adaptive ZSL ISP engine 40 may implement one or more of the adaptive buffering technologies of this disclosure. As described above, the adaptive buffering rate technologies of this disclosure may be implemented in various forms, such as by way of selection from a predetermined set of fixed-value buffering rates, or by way of adaptively tuning or adjusting the buffering rate based on scene-change metrics received from statistical analysis circuitry 16.

In the example implementation shown in FIG. 2, adaptive ZSL ISP engine 40 includes ZSL buffering circuitry 42, rate adjustment circuitry 44, and dynamic statistics processing circuitry 46. Adaptive ZSL ISP engine 40 may also include other circuitry configured to perform filtering and other image-processing functionalities, but these components are not shown in FIG. 2 for ease of illustration. ZSL buffering circuitry 42 may enable adaptive ZSL ISP engine 40 to support ZSL, which improves the user experience with respect to capturing digital photographs using mobile computing device 2.

As described above, adaptive ZSL ISP engine 40 is a front-end image processing hardware component configured to refine or “touch up” pictures received from camera unit 4. ZSL buffering circuitry 42 may include, be, or be part of one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry. ZSL buffering circuitry 42 may be configured to provide ZSL support, by continually buffering the touched-up pictures to snapshot buffer 10 implemented within DDR 8.

Dynamic statistics processing circuitry 46 may include, be, or be part of one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry. Dynamic statistics processing circuitry 46 may be configured to processing scene-change metrics received from statistical analysis circuitry 16. For instance, dynamic statistics processing circuitry 46 may be configured to continually determine the level of motion in pictures received from camera unit 4. More specifically, dynamic statistics processing circuitry 46 may use scene-change metrics received from statistical analysis circuitry 16 to determine the degree of motion exhibited by a picture.

In grade-based implementations, dynamic statistics processing circuitry 46 may determine a “class” or category of motion to which the picture belongs. In granular implementations, dynamic statistics processing circuitry 46 may determine an exact or approximate percentage of motion exhibited by the picture relative to a previously buffered picture. In either type of implementation, dynamic statistics processing circuitry 46 may provide motion analysis information to rate adjustment circuitry 44 of adaptive ZSL ISP engine 40. Rate adjustment circuitry 44 may include, be, or be part of one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry.

Using the motion analysis information received from dynamic statistics processing circuitry 46, rate adjustment circuitry 44 may determine an adjusted buffering rate to be implemented to support ZSL in accordance with aspects of this disclosure. Examples are described below with respect to granular implementations of scene-change metric reporting by statistical analysis circuitry 16. For instance, if dynamic statistics processing circuitry 46 provides information indicating a 0% change with respect to a picture, then rate adjustment circuitry 44 may reduce the default ZSL buffering rate to one-third (˜33.33%) of its original value. In this example, the skip rate is two-thirds (˜66.67%), because the skip rate represents a difference between the total original buffering rate (100%) and the reduced buffering rate (˜33.33%).

If dynamic statistics processing circuitry 46 provides information indicating a scene change that is greater than 0% but less than or equal to 2%, then rate adjustment circuitry 44 may reduce the default ZSL buffering rate to one-half (50%) of its original value. In this example, the skip rate is one-half (50%), because the skip rate represents a difference between the total original buffering rate (100%) and the reduced buffering rate (50%). If dynamic statistics processing circuitry 46 provides information indicating a scene change that is greater than 2% but less than or equal to 5%, then rate adjustment circuitry 44 may reduce the default ZSL buffering rate to two-thirds (˜66.67%) of its original value. In this example, the skip rate is one-third (˜33.33%), because the skip rate represents a difference between the total original buffering rate (100%) and the reduced buffering rate (˜66.67%).

In turn, rate adjustment circuitry 44 may provide the reduced adjustment buffering rate to ZSL buffering circuitry 42. In various examples, rate adjustment circuitry 44 may provide buffering rate notifications to ZSL buffering circuitry 42 on an ongoing basis, and in other examples, rate adjustment circuitry may communicate an adjusted buffering rate to ZSL buffering circuitry on as-needed basis, such as upon rate adjustment circuitry 44 changing an existing buffering rate. Upon receiving a notification of an adjusted buffering rate from rate adjustment circuitry 44, ZSL buffering circuitry 42 may begin storing touched-up pictures to snapshot buffer 10 according to the latest buffering rate provided by rate adjustment circuitry 44.

Applying one of the example use cases described above, rate adjustment circuitry 44 may use scene-change metrics received from dynamic statistics processing circuitry 46 to implement a skip rate of two-thirds. In other words, rate adjustment circuitry 44 may determine an adjusted buffering rate that is one-third of the default buffering rate. In this example, rate adjustment circuitry 44 may communicate the adjusted (one-third) buffering rate to ZSL buffering circuitry 42. Alternatively, rate adjustment circuitry 44 may communicate the two-thirds skip rate to ZSL buffering circuitry 42, thereby enabling ZSL buffering circuitry 42 to derive the adjusted (one-third) buffering rate.

In any event, ZSL buffering circuitry 42 may store the touched-up pictures to snapshot buffer 10 at the adjusted buffering rate, which is one-third of the default ZSL-supporting buffering rate. Expressed in terms of the adjusted buffering rate, ZSL buffering circuitry 42 may store, to snapshot buffer 10, only one out of every three touched-up pictures that ZSL buffering circuitry 42 would store under the default buffering rate. Expressed in terms of the skip rate, ZSL buffering circuitry 42 may skip storing (or omit the storage of) two out of every three touched-up pictures that ZSL buffering circuitry 42 would store under the default buffering rate. ZSL buffering circuitry 42 may implement the adjusted buffering rate on a per-three-pictures basis. That is, ZSL buffering circuitry 42 may implement the one-third buffering rate (or two-thirds skip rate) with respect to discrete sets of three consecutive pictures, in chronological order of receipt.

Moreover, the configurations described above with respect to ZSL buffering circuitry 42, rate adjustment circuitry 44, and dynamic statistics processing circuitry 46 may enable adaptive ZSL ISP engine 40 to leverage existing memory access-requesting infrastructure. For instance, adaptive ZSL ISP engine 40 may include circuitry (not expressly shown in FIG. 2) configured to implement DDR voting, which adaptive ZSL ISP engine 40 may use to contest for read-write access to DDR 8. Adaptive ZSL ISP engine 40 may continue to use the existing DDR-voting configurations that are used for default ZSL buffering rates, while supporting the adaptive buffering rates of this disclosure.

In this manner, the adaptive buffering rate adjustments of this disclosure are backward compatible with DDR voting schemes that adaptive ZSL ISP engine 40 may implement, in accordance with existing ZSL-supporting configurations. However, in cases where rate adjustment circuitry 44 provides ZSL buffering circuitry 42 with a reduced buffering rate, the frequency with which adaptive ZSL ISP engine 40 generates DDR votes is reduced, because of ZSL buffering circuitry 42 submitting fewer pictures for storage to snapshot buffer 10. By causing a reduction in DDR votes, ZSL buffering circuitry 42 may free up DDR 8 for use by other client hardware of mobile computing device 2, such as but not limited to GPU 17.

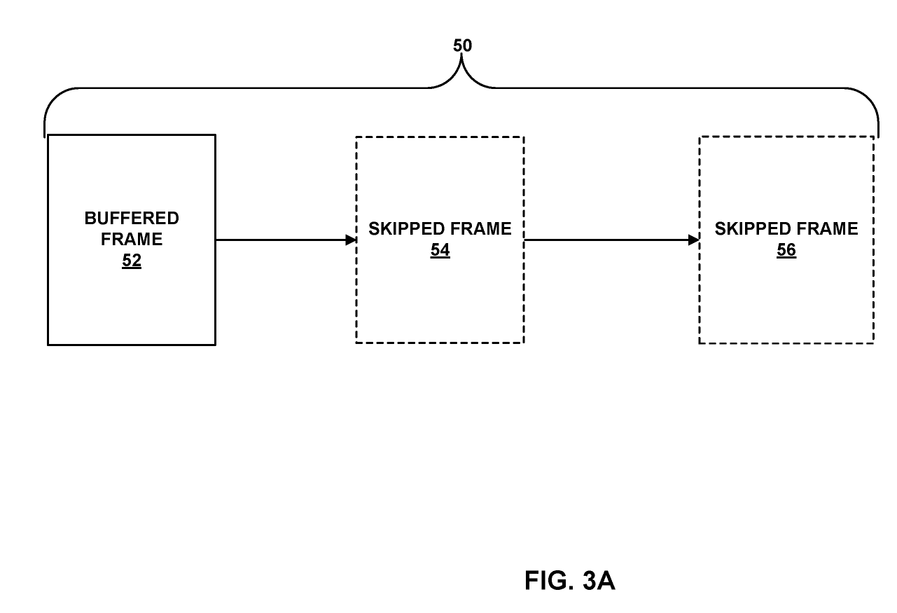

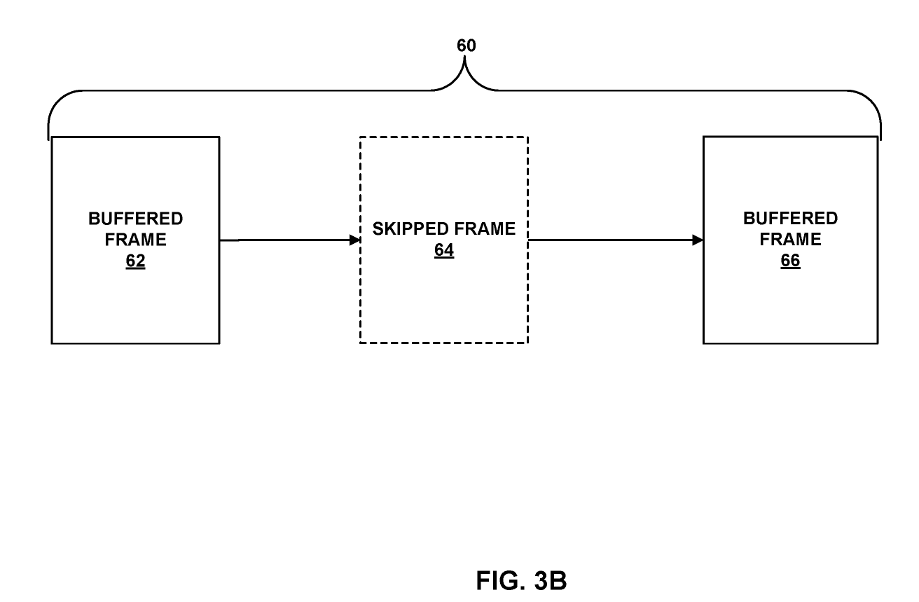

FIGS. 3A and 3B are conceptual diagrams illustrating frame sequences that adaptive ZSL ISP engine 40 may buffer at different adaptive buffering rates. Said another way, FIGS. 3A and 3B illustrate different skip rates according to the adaptive buffering technologies of this disclosure. FIG. 3A illustrates an example in which rate adjustment circuitry 44 implements a two-thirds skip rate, which yields a reduced buffering rate that is one-third of the original default buffering rate. Picture sequence 50 of FIG. 3A illustrates three pictures that are touched-up on the front end by adaptive ZSL ISP engine 40. The three pictures of picture sequence 50 represent three images consecutively received via the photo-sensing hardware of camera unit 4.

As described above, in processing picture sequence 50 of FIG. 3A, adaptive ZSL ISP engine 40 may skip two out of every three pictures, with respect to storing picture sequence 50 to snapshot buffer 10. As such, picture sequence 50 includes a buffered frame 52, which is followed by two buffered frames 54 and 56. In the particular example of picture sequence 50, adaptive ZSL ISP engine 40 selects the first picture, namely, buffered frame 52, to store to snapshot buffer 10. In this example, adaptive ZSL ISP engine 40 omits the two following pictures, namely skipped frames 54 and 56, from storage to snapshot buffer 10. Skipped frames 54 and 56 are illustrated in FIG. 3A with dashed-line borders, to indicate their omission from snapshot buffer 10.

In various examples, buffered frame 52 may not be the first of a three-picture sequence, but instead, may be in the middle (e.g., bookended by skipped frames 54 and 56), or at the end (e.g., preceded by both skipped frames 54 and 56). As such, it will be appreciated that picture sequence 50 is just one example of a “sliding window” of three pictures, of which adaptive ZSL ISP engine 40 may omit two pictures from storing to snapshot buffer 10. In some examples, picture sequence 50 of FIG. 3A may correspond to a two-thirds skip rate determined by rate adjustment circuitry 44 in response to dynamic statistics processing circuitry 46 indicating that a picture (e.g. that is included in picture sequence 50 or preceded picture sequence 50 in receipt order) exhibited some non-zero amount of motion that is less than or equal to 2%. As such, picture sequence 50 may be associated with a low-motion scene, or low-end target.

FIG. 3B illustrates an example in which rate adjustment circuitry 44 implements a one-third skip rate, which yields a reduced buffering rate that is two-thirds of the original default buffering rate. Picture sequence 60 of FIG. 3B illustrates three pictures that are touched-up on the front end by adaptive ZSL ISP engine 40. The three pictures of picture sequence 60 represent three images consecutively received via the photo-sensing hardware of camera unit 4.

As described above, in processing picture sequence 60 of FIG. 3B, adaptive ZSL ISP engine 40 may skip one out of every three pictures, with respect to storing picture sequence 60 to snapshot buffer 10. As such, picture sequence 60 includes a skipped frame 64, which is bookended by buffered frames 62 and 66. In the particular example of picture sequence 60, adaptive ZSL ISP engine 40 selects the first picture, namely, buffered frame 62, and the last picture, namely buffered frame 66, to store to snapshot buffer 10. In this example, adaptive ZSL ISP engine 40 omits the middle picture, namely skipped frame 64, from storage to snapshot buffer 10. Skipped frame 64 is illustrated in FIG. 3B with dashed-line borders, to indicate its omission from snapshot buffer 10.

In various examples, skipped frame 64 may not be the second of a three-picture sequence, but instead, may be at the beginning (e.g., followed by buffered frames 62 and 66), or at the end (e.g., preceded by both of buffered frames 62 and 66). As such, it will be appreciated that picture sequence 60 is just one example of a “sliding window” of three pictures, of which adaptive ZSL ISP engine 40 may omit one picture from storing to snapshot buffer 10. In some examples, picture sequence 60 of FIG. 3A may correspond to a one-third skip rate determined by rate adjustment circuitry 44 in response to dynamic statistics processing circuitry 46 indicating that a picture (e.g. that is included in picture sequence 60 or preceded picture sequence 60 in order of receipt) exhibited some amount of motion that exceeds 2%, but is less than or equal to 5%.

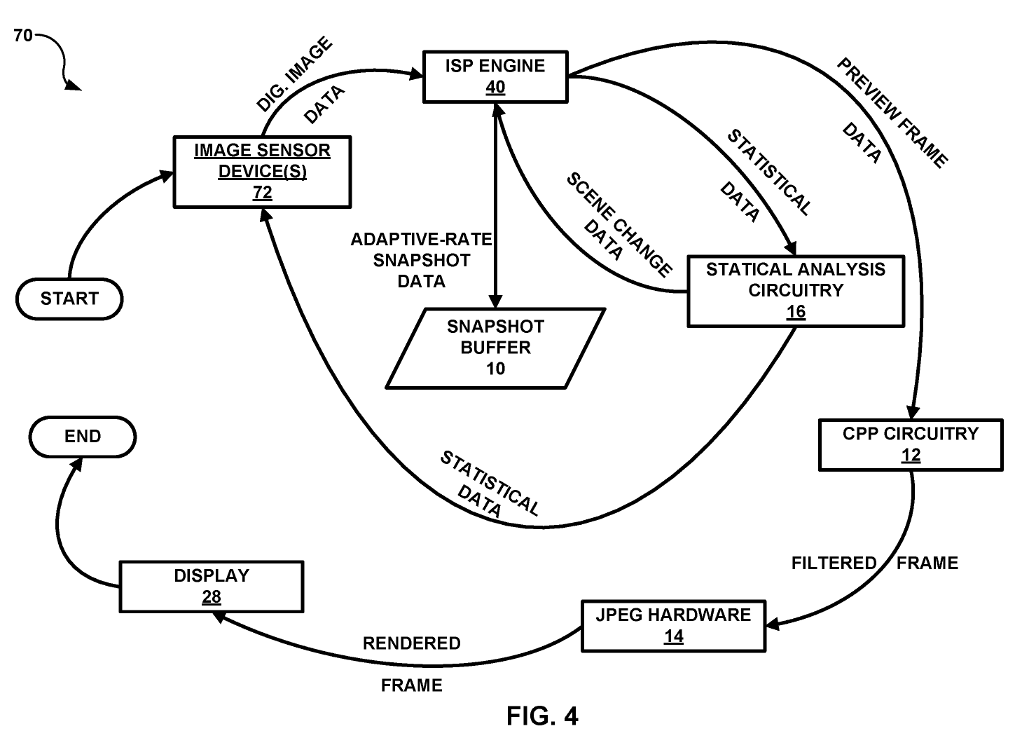

FIG. 4 is a data flow diagram (DFD) 70 illustrating an example of interactive operation of various hardware components of mobile computing device 2 configured to perform various aspects of the techniques described in this disclosure. At the start of DFD 70, image sensor device(s) 72 may receive or already have access to raw image data. Image sensor device(s) 72 represent various lens-sensor hardware combinations provided by camera unit 4. Image sensor device(s) 72 may provide digital image data to adaptive ZSL ISP engine 40 (referred to as “ISP engine 40” for brevity in this discussion of DFD 70). In turn, ISP engine 40 may perform front-end processing of the digital image data received from image sensor device(s) 72 to better condition the digital image data to be presented to one or more users via display 28. The conditioned digital image data is referred to herein as “preview frame data.”

ISP engine 40 may provide data to CPP circuitry 12 and to statistical analysis circuitry 16. It will be appreciated that ISP engine 40 may provide data to one or both of CPP circuitry 12 and/or statistical analysis circuitry 16 either directly, or indirectly, such as by having the data relayed through some intervening hardware. Moreover, while ISP engine 40 may provide either identical or varying data to CPP circuitry 12 and statistical analysis circuitry 16, the data provided to each of these components is illustrated in FIG. 4 as being different, to facilitate discussion of pertinent data that is processed by each of these components.

As shown in DFD 70, ISP engine 40 may provide preview frame data to CPP circuitry 12, and may provide statistical data to statistical analysis circuitry 16. For instance, ISP engine 40 may provide preview frame data with metadata to statistical analysis circuitry, thereby enabling statistical analysis circuitry 16 to extract image-describing statistics from the metadata. In turn, statistical analysis circuitry 16 may implement techniques of this disclosure to extrapolate scene-change data for a preview frame, and provide the scene-change data to ISP engine 40. Additionally, statistical analysis circuitry 16 may provide statistical data to image sensor device(s) 72.

ISP engine 40 may implement technologies of this disclosure to adjust a buffering rate for ZSL support. For instance, ISP engine 40 may reduce the buffering rate from the default buffering rate used for ZSL support. In turn, ISP engine 40 may store snapshot data, using the adaptive buffering rate, to snapshot buffer 10. Snapshot data may be read out of snapshot buffer 10 based on a capture command, such as in cases where CPP circuitry 12 extracts snapshot data in response to a user command to capture a photograph. Various three-picture microcosms of different adaptive rates that ISP engine 40 may use are illustrated in FIGS. 3A and 3B. It will be appreciated that ISP engine 40 may implement adaptive buffering rates that are different from the specific examples discussed in this disclosure, in accordance with the configurations provided by this disclosure.

As discussed above, snapshot buffer 10 is implemented within DDR 8. Experimental results have shown that the two-thirds skip rate configuration of this disclosure and illustrated in FIG. 3A yields a power saving of approximately twenty-five (25) milliamps (mA) with respect to the drain on battery 31, with respect to a 13 megapixel image resolution. In some experimental results, under which ISP engine 40 implements a greater skip rate than two-thirds, a power saving of approximately 40 mA for the use of battery 31 is observed with respect 13 megapixel image resolutions. In many examples, DDR 8 may support a maximum data rate of four gigabytes (4 GB). ISP engine 40 may reducing the data rate burden to below the data rate burden consumed by a full buffering rate (e.g., below the maximum data rate) when implementing a skip rate of this disclosure. The 25 mA power saving may correspond to an effective ZSL buffering rate of 15 fps according to a skip rate of this disclosure, and the 40 mA power saving may correspond to a “skip all” mode in which no ZSL frame was written to the buffer (e.g., resulting in a 0 fps ZSL buffering rate for some period of time).

Based on a user input indicating a request capture a photograph, CPP circuitry 12 may apply various filters to further refine the preview frame data received from ISP circuitry 40, to form one or more filtered frames. In turn, CPP circuitry 12 may provide the filtered frame(s) to JPEG hardware 14. In turn, JPEG hardware 14 may render the filtered frame(s) to form one or more rendered frames. JPEG hardware 14 may, directly or indirectly, provide the rendered frame(s) to display 28 for output in a visually discernible form.

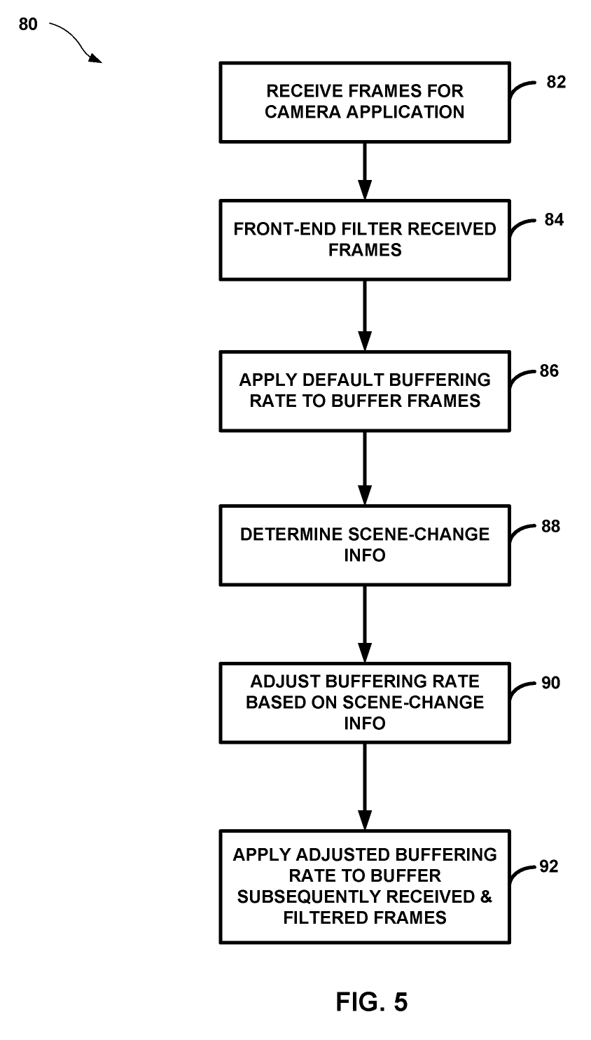

FIG. 5 is a flowchart illustrating an example process 80 by which mobile computing device 2 may implement the adaptive buffering rate technologies of this disclosure to mitigate resource consumption while supporting the enhanced user experience provided by ZSL. Process 80 may begin when camera unit 4 receives a series of frames for a camera application executing on mobile computing device 2 (82). For instance, photo-detecting hardware of camera unit 4 may receive image data for a stream of pictures to support still photograph and/or video capture capabilities of mobile computing device 2.

In turn, ISP circuitry 6 may apply front-end filtering to the frames received via camera unit 4 (84). As discussed above, ISP circuitry 6 may touch up or refine the received frames so that the pictures can be output via display 28 to a user in chronological order of receipt. Additionally, ISP circuitry 6 may apply a default buffering rate to store the touched-up frames to snapshot buffer 10 to support ZSL (86). For instance, in instances where camera unit 4 supports a 30 fps frame rate, ISP circuitry 6 may store 30 touched-up pictures to snapshot buffers per second, but may implement write-and-erase functionalities to maintain the three most recently-received frames in snapshot buffer 10 at any given time.

Statistical analysis circuitry 16 may determine scene-change information for a picture (snapshot frame) that is extracted from snapshot buffer 10 (88). For instance, statistical analysis circuitry 16 may extrapolate motion information of the picture using metadata (e.g., color transitions, white balance transitions, blurring, etc.) to determine a degree or level of scene-change exhibited by the picture, relative to one or more previously buffered pictures. Based on the scene-change information communicated by statistical analysis circuitry 16, ISP circuitry 6 may adjust the buffering rate for ZSL support (90). For instance, statistical analysis circuitry 6 may be configured, according to aspects of this disclosure, to communicate the scene-change information to ISP circuitry 6. Moreover, ISP circuitry 6 may be configured, according to aspects of this disclosure, to use the scene-change information to obtain an adjusted ZSL buffering rate, in order to potentially mitigate power consumption and resource usage to support ZSL.

For instance, ISP circuitry 6 may reduce the default buffering rate if ISP circuitry 6 determines that the scene-change information indicates that a photo-sensing interface of camera unit 4 is aimed at a relatively stationary scene, or “low end target.” An example of a low end target may be a nature scene, which has some, but very little disturbance due to mild wind or drizzle conditions. In contrast, an example of a high end target (which reflects a more mobile scene) is a scene with a moving train. In cases of statistical analysis circuitry 16 providing scene-change information indicating a high end target, ISP circuitry 6 may not reduce the default buffering rate at all, or may reduce the ZSL buffering target using a smaller skip rate than the skip rate used for low end targets. In any event, after adjusting the buffering rate based on the scene-change information received from statistical analysis circuitry 16, ISP circuitry 6 may apply the adjusted buffering rate to store subsequently received and front-end filtered frames to snapshot buffer 10 (92).

For instance, statistical analysis circuitry 16 and/or ISP circuitry may determine that a currently-photographed scene is a low end target. The camera hardware of camera unit 4 may continue to receive images at a capture rate denoted by ‘N’ pictures per unit time (e.g., N fps). Additionally, ISP circuitry 6 may continue to touch up all frames received from camera unit 4. However, in this case, ISP circuitry 6 may buffer only a subset of the N frames received in the unit time, such as by buffering ‘M’ touched-up frames, where M has a lesser value than N. As such, ISP circuitry 6 may change the buffering scheme to support an M fps buffering rate. ISP circuitry 6 may determine the M:N ratio based on the granular motion information supplied by statistical analysis circuitry 16, or based on the scene-change grade assigned by statistical analysis circuitry 16. In various examples, statistical analysis circuitry 16 may determine the degree of motion on a pixel-by-pixel basis, on a per-block basis, or on a global basis (e.g., based on a length of motion vectors). In the case of a pixel-by-pixel analysis, statistical analysis circuitry may apply various motion-determinative techniques, such as like sum of absolute difference (SAD), sum of squared difference (SSD), mean absolute difference (MAD), or mean of squared difference (MSD). It will be appreciated that, in various examples, ISP circuitry 6 may also increase the buffering rate. For instance, if ISP circuitry 6 is currently implementing a reduced buffering rate, and statistical analysis circuitry 16 provides an indication of increased motion, then ISP circuitry 6 may increase the buffering rate to accommodate a high-end, or higher-end target.

One example workflow of the techniques of this disclosure is described below. ISP circuitry 6 may buffer a first picture of a sequence of received, touched-up frames. ISP circuitry 6 may buffer a second picture of the sequence of received, touched-up frames (e.g., after completion of buffering the first picture of the sequence). Statistical analysis circuitry 16 may determine an amount of motion between the first frame and a second frame. ISP circuitry 6 may determine a picture buffering rate according to the amount of motion. ISP circuitry 6 may prevent buffering of one or more frames of the sequence of received, touched-up frames following the second frame according to the picture buffering rate. The frames that ISP circuitry 6 prevents from being buffered may be referred to herein as “skipped pictures” or “skipped frames.” In turn, ISP circuitry 6 may buffer a third picture of the sequence of received, touched-up frames following the skipped frame.

Another example workflow of the techniques of this disclosure is described below. Statistical analysis circuitry 16 may determine a first amount of motion in a first scene. For instance, the first scene may occur prior to a scene change that is described by scene-change information. ISP circuitry 6 may determine a first buffering rate based on the first amount of motion. Statistical analysis circuitry 16 may determine a second amount of motion in a second scene. the second scene may occur subsequent (or subsequently) to the scene change that is described by scene-change information. ISP circuitry 6 may determine a second buffering rate based on the second amount of motion.

In one or more examples, the functions described may be implemented in hardware, software, firmware, or any combination thereof. If implemented in software, the functions may be stored on, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, processing circuitry (including fixed function circuitry and/or programmable processing circuitry), application specific integrated circuits (ASICs), field programmable logic arrays (FPGAs), or other equivalent integrated circuitry or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A mobile computing device having digital camera capabilities, the mobile computing device comprising:
camera hardware configured to receive a plurality of frames;
a memory device that implements a buffer; and
processing circuitry coupled to the camera hardware and to the memory device and being configured to:
store a first subset of the plurality of received frames to the buffer according to a first buffering rate;
determine scene-change information associated with at least one received frame of the plurality of received frames;
determine a second buffering rate based on the determined scene-change information; and
store a second subset of the plurality of received frames to the buffer according to the second buffering rate, the second subset of the plurality of received frames comprising different pictures from pictures of the first subset of the plurality of received frames.

2. The mobile computing device of claim 1, wherein the processing circuitry is configured to:
determine a skip rate based on the determined scene-change information such that a magnitude of the skip rate is directly proportional to one or more scene-change metrics described by the scene change information; and
reduce the first buffering rate by the skip rate to determine the second buffering rate.

3. The mobile computing device of claim 1, wherein the processing circuitry is configured to:
analyze statistical data describing the at least one picture to determine the scene-change information; and
generate the one or more scene-change metrics that are described by the scene-change information based on the analysis of the statistical data.

4. The mobile computing device of claim 3, wherein the scene-change metrics include a percentage of motion representative of an amount of motion in the at least one picture with respect to a reference picture that is included in the plurality of received frames, and
wherein the processing circuitry is configured to determine the second buffering rate based on the percentage of motion included in the scene-change metrics.

5. The mobile computing device of claim 3, wherein to generate the scene-change metrics, the processing circuitry is configured to assign a scene-change grade to the at least one picture, based on the percentage of motion information that compares the at least one picture to a reference picture that is included in the plurality of received frames, and wherein the processing circuitry is configured to determine the scene-change grade as a category of scene-change information that includes the determined one or more scene-change metrics.

6. The mobile computing device of claim 1, wherein to determine the scene-change information, the processing circuitry is configured to analyze one or more of color transition information, motion blur information, white balance change information, sharpness change information, or red-green-blue (RBG) filtering gain information between the at least one picture and a reference picture of the plurality of received frames.

7. The mobile computing device of claim 1, wherein the second buffering rate has a frames-per-second (fps) value that is one of:
one-third of a corresponding fps value of the first buffering rate, or
one-half of the corresponding fps value of the first buffering rate, or
two-thirds of the corresponding fps value of the first buffering rate.

8. The mobile computing device of claim 1, wherein the processing circuitry comprises:
image signal processing (ISP) circuitry configured to:
perform front-end filtering on all received frames of the plurality of received frames; and
store all of the front-end filtered pictures to the buffer;
camera post-processing (CPP) circuitry configured to:
extract one or more of the front-end filtered pictures from the buffer, in response to an indication of a capture command; and
apply back-end filtering on the one or more extracted pictures; and
statistical analysis circuitry configured to extract metadata from the one or more extracted pictures, the metadata being descriptive of the scene-change information.

9. The mobile computing device of claim 8, further comprising:
a display coupled to the processing circuitry, the display being configured to output one or more of the front-end filtered pictures or the extracted pictures for display; and
input processing circuitry coupled to the CPP circuitry, the input processing circuitry being configured to generate the indication of the capture command.

10. The mobile computing device of claim 1, wherein the processing circuitry is configured to access the memory device according to a voting scheme in which the processing circuitry generates one or more votes within a unit of time, and wherein the number of the one or more votes is directly proportional to frames-per-unit-time measurements of the first buffering rate and the second buffering rate.

11. A method of image processing, the method comprising:
receiving, by camera hardware of a mobile computing device, a plurality of frames;
storing, by processing circuitry, a first subset of the plurality of received frames to a buffer, according to a first buffering rate;
determining, by the processing circuitry, scene-change information associated with at least one received frame of the plurality of received frames;
determining, by the processing circuitry, a second buffering rate based on the determined scene-change information; and
storing, by the processing circuitry, a second subset of the plurality of received frames to the buffer according to the second buffering rate, the second subset of the plurality of received frames comprising different pictures from pictures of the first subset of the plurality of received frames.

12. The method of claim 11, further comprising:
determining, by the processing circuitry, a skip rate based on the determined scene-change information such that a magnitude of the skip rate is directly proportional to one or more scene-change metrics described by the scene change information; and
reducing, by the processing circuitry, the first buffering rate by the skip rate to determine the second buffering rate.

13. The method of claim 11, further comprising:
analyzing, by the processing circuitry, statistical data describing the at least one picture to determine the scene-change information; and
generating, by the processing circuitry, the one or more scene-change metrics that are described by the scene-change information based on the analysis of the statistical data.

14. The method of claim 13,
wherein the scene-change metrics include a percentage of motion representative of an amount of motion in the at least one picture with respect to a reference picture that is included in the plurality of received frames, and
wherein determining the second buffering rate comprises determining the second buffering rate based on the percentage of motion included in the scene-change metrics.

15. The method of claim 13,
wherein generating the scene-change metrics comprises assigning, by the processing circuitry, a scene-change grade to the at least one picture, based on motion that compares the at least one picture based on the percentage of motion information that compares the at least one picture to a reference picture that is included in the plurality of received frames, and
wherein determining the scene-change grade comprises determining the scene-change grade as a category of scene-change information that includes the determined one or more scene-change metrics.

16. The method of claim 11, wherein determining the scene-change information comprises analyzing, by the processing circuitry, one or more of color transition information, motion blur information, white balance change information, sharpness change information, or red-green-blue (RBG) filtering gain information between the at least one picture and a reference picture of the plurality of received frames.

17. The method of claim 11, wherein the second buffering rate has a frames-per-second (fps) value that is one of:
one-third of a corresponding fps value of the first buffering rate, or
one-half of the corresponding fps value of the first buffering rate, or
two-thirds of the corresponding fps value of the first buffering rate.

18. The method of claim 11, further comprising:
performing, by image signal processing (ISP) circuitry of the processing circuitry, front-end filtering on all received frames of the plurality of received frames;
storing, by the ISP circuitry, all of the front-end filtered pictures to the buffer;
extracting, by camera post-processing (CPP) circuitry of the processing circuitry, one or more of the front-end filtered pictures from the buffer, in response to an indication of a capture command;
applying, by the CPP circuitry, back-end filtering on the one or more extracted pictures; and
extracting, by statistical analysis circuitry, metadata from the one or more extracted pictures, the metadata being descriptive of the scene-change information.

19. The method of claim 18,
wherein determining the second buffering rate comprises determining, by the processing circuitry, the second buffering rate as a function of the first buffering rate such that the function is based on the determined scene-change information.

20. The method of claim 11, wherein the first subset of the plurality of received frames is associated with a first scene occurring prior to a scene change described by the scene-change information, and where in the second subset of the plurality of received frames is associated with a second scene occurring subsequently to the scene change described by the scene-change information.

21. An apparatus for image processing, the apparatus comprising:
means for receiving a plurality of frames;
means for buffering a first subset of the plurality of received frames according to a first buffering rate;
means for determining scene-change information associated with at least one received frame of the plurality of received frames;
means for determining, based on the determined scene-change information, a second buffering rate; and
means for buffering a second subset of the plurality of received frames according to the second buffering rate, the second subset of the plurality of received frames comprising different pictures from pictures of the first subset of the plurality of received frames.

22. A non-transitory computer-readable storage medium encoded with instructions that, when executed, cause one or more processors of an image-processing device to:
receive a plurality of frames;
buffer a first subset of the plurality of received frames according to a first buffering rate;
determine scene-change information associated with at least one received frame of the plurality of received frames;
determine, based on the determined scene-change information, a second buffering rate; and
buffer a second subset of the plurality of received frames according to the second buffering rate, the second subset of the plurality of received frames comprising different pictures from pictures of the first subset of the plurality of received frames.
